(19) United States
(12) Patent Application Publication
(10) Pub. No.: US 2025/0307083 A1
(43) Pub. Date: Oct. 2, 2025

(54) METHOD AND SYSTEM FOR MANAGING DATA BACKUP

(71) Applicant: HCL Technologies Limited, New Delhi (IN)

(72) Inventors: Veera Venkata Paparao Gokavarapu, Bangalore (IN); Gangadhar Markande, Bangalore (IN)

(21) Appl. No.: 19/173,797

(22) Filed: Apr. 8, 2025

(30) Foreign Application Priority Data
Mar. 27, 2024 (IN) 202411024606

(51) Int. Cl. G06F 11/14; G06F 9/451

(52) U.S. Cl. CPC G06F 11/1458; G06F 9/451

(57) ABSTRACT

This disclosure relates to method and system for managing data backup. The method may include receiving a time period since previous data backup and a size of the unbacked-up data from a user device. When the size of the unbacked-up data is greater than or equal to a predefined threshold data size, the method may include initiating a data backup of the unbacked-up data. The method may further include storing the unbacked-up data in a database. When the size of the unbacked-up data is less than the predefined threshold data size and when the time period since previous data backup is equal to a predefined backup time period, the method may include initiating the data backup of the unbacked-up data. The method may further include storing the unbacked-up data in the database.

### TECHNICAL FIELD

This disclosure relates generally to the field of data backup, and more particularly to method and system for managing data backup.

### BACKGROUND

Data backups can be of two types: either manual or scheduled backup. Manual backup is triggered by a user to safely store the data as and when required. In a scheduled backup, the user defines backup time periods (e.g., daily, weekly, or monthly). The schedule is stored on a server for future scheduled backup operations. The server triggers backup of the data whenever scheduled backup time is reached and communicates with client to prepare the backup data.

As data generation and consumption is growing day by day, the data protection has become feeble. The scheduled periods may accumulate an exuberant amount of data to backup, or an intermittent backup failure may skip the backup cycle and may need to await next backup schedule to complete successfully. This may conglomerate the data until the next backup cycle.

In the present state of art, backup technologies based on the scheduled backup cycle have bottlenecks as the data generation is non-linear. Increasing the frequency of the scheduled backup may not be optimal as it may fail to handle exuberant data generation.

### SUMMARY

In one embodiment, a method for managing data backup may be disclosed. In one example, the method may include receiving, by a server, a time period since previous data backup and a size of the unbacked-up data from a user device. The method may further include comparing, by the server, the size of the unbacked-up data with a predefined threshold data size. When the size of the unbacked-up data may be greater than or equal to the predefined threshold data size, the method may further include initiating, by the server, a data backup of the unbacked-up data. The method may further include storing, by the server, the unbacked-up data in a database. When the size of the unbacked-up data may be less than the predefined threshold data size, the method may further include comparing, by the server, the time period since previous data backup with a predefined backup time period. When the time period since previous data backup may be equal to the predefined backup time period, the method may further include initiating, by the server, the data backup of the unbacked-up data. The method may further include storing, by the server, the unbacked-up data in the database.

In one embodiment, a system for managing data backup may be disclosed. In one example, the system may include a processor and a computer-readable medium communicatively coupled to the processor. The computer-readable medium may store processor-executable instructions, which, on execution, may cause the processor to receive a time period since previous data backup and a size of the unbacked-up data from a user device. The processor-executable instructions, on execution, may further cause the processor to compare the size of the unbacked-up data with a predefined threshold data size. When the size of the unbacked-up data may be greater than or equal to the predefined threshold data size, the processor-executable instructions, on execution, may further cause the processor to initiate a data backup of the unbacked-up data. The processor-executable instructions, on execution, may further cause the processor to store the unbacked-up data in a database. When the size of the unbacked-up data may be less than the predefined threshold data size, the processor-executable instructions, on execution, may further cause the processor to compare the time period since previous data backup with a predefined backup time period. When the time period since previous data backup may be equal to the predefined backup time period, the processor-executable instructions, on execution, may further cause the processor to initiate the data backup of the unbacked-up data. The processor-executable instructions, on execution, may further cause the processor to store the unbacked-up data in the database.

In one embodiment, a non-transitory computer-readable medium storing computer-executable instructions for managing data backup may be disclosed. In one example, the stored instructions, when executed by a processor, may cause the processor to perform operations including receiving a time period since previous data backup and a size of the unbacked-up data from a user device. The operations may further include comparing the size of the unbacked-up data with a predefined threshold data size. When the size of the unbacked-up data may be greater than or equal to the predefined threshold data size, the operations may further include initiating a data backup of the unbacked-up data. The operations may further include storing the unbacked-up data in a database. When the size of the unbacked-up data may be less than the predefined threshold data size, the operations may further include comparing the time period since previous data backup with a predefined backup time period. When the time period since previous data backup may be equal to the predefined backup time period, the operations may further include initiating the data backup of the unbacked-up data. The operations may further include storing the unbacked-up data in the database.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for managing data backup, in accordance with some embodiments.

FIG. 2 illustrates a functional block diagram of an exemplary server implemented by the exemplary system of FIG. 1, in accordance with some embodiments.

FIG. 3 illustrates a flow diagram of an exemplary process for managing data backup, in accordance with some embodiments.

FIG. 4 illustrates a flow diagram of an exemplary process for managing data backup, in accordance with some embodiments.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

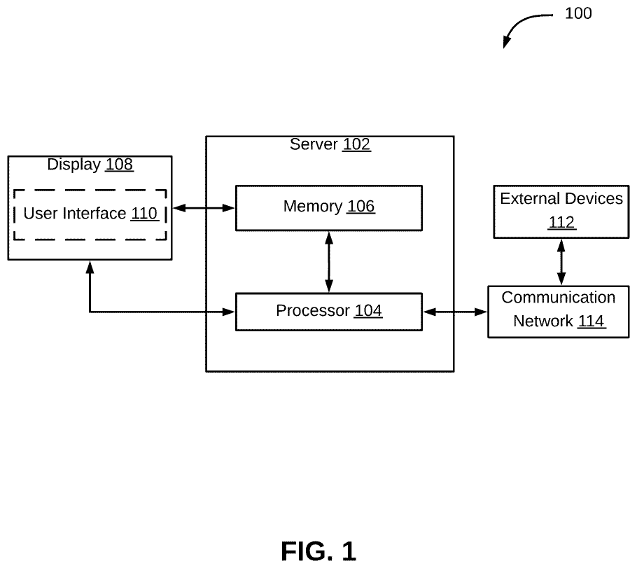

Referring now to FIG. 1, an exemplary system 100 for managing data backup is illustrated, in accordance with some embodiments. The system 100 may implement a server 102 (for example, server, desktop, laptop, notebook, netbook, tablet, smartphone, mobile phone, or any other computing device), in accordance with some embodiments of the present disclosure. The server 102 may manage data backup through a hybrid criteria based on a time period since previous data backup and a size of the unbacked-up data in a user device.

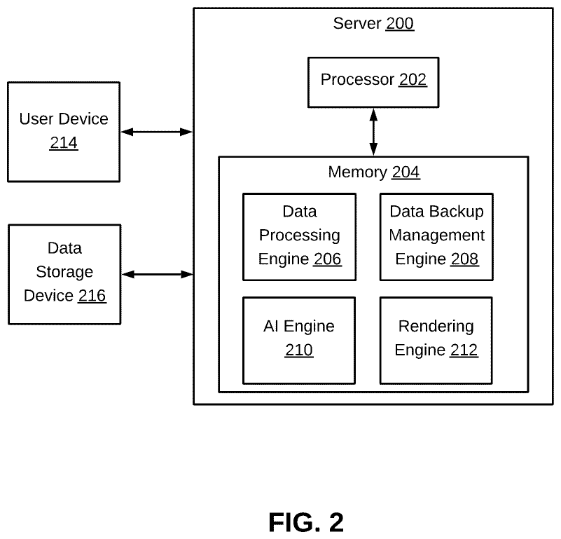

As will be described in greater detail in conjunction with FIGS. 2-4, the server 102 may receive a time period since previous data backup and a size of the unbacked-up data from a user device. The server 102 may further compare the size of the unbacked-up data with a predefined threshold data size. When the size of the unbacked-up data is greater than or equal to the predefined threshold data size, the server 102 may further initiate a data backup of the unbacked-up data and store the unbacked-up data in a database. When the size of the unbacked-up data is less than the predefined threshold data size, the server 102 may further compare the time period since previous data backup with a predefined backup time period. When the time period since previous data backup is equal to the predefined backup time period, the server 102 may further initiate the data backup of the unbacked-up data and store the unbacked-up data in the database.

In some embodiments, the server 102 may include one or more processors 104 and a memory 106. The memory 106 may include the database. Further, the memory 106 may store instructions that, when executed by the one or more processors 104, cause the one or more processors 104 to manage data backup, in accordance with aspects of the present disclosure. The memory 106 may also store various data (for example, time period since previous data backup, size of unbacked-up data, set of historical user data metrics, Artificial Intelligence (AI) model parameters, and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the server 102 may interact with the one or more external devices 112 over a communication network 114 for sending or receiving various data. The external devices 112 may include, but may not be limited to, a remote server, a digital device, or another computing system.

Referring now to FIG. 2, functional block diagram of an exemplary server 200 (analogous to the server 102 implemented by the system 100) is illustrated, in accordance with some embodiments. The server 200 includes a processor 202 and a memory 204. The processor 202 may be communicatively coupled with the memory 204. The memory 204 may include a data processing engine 206, a data backup engine 208, an Al engine 210, and a rendering engine 212. The data processing engine 206 may receive a set of user data metrics from a user device 214. The set of user data metrics may include a time period since previous data backup and a size of the unbacked-up data from a user device 214. Further, the data processing engine 206 may initiate a first level of validation for data backup. The first level of validation may be based on the size of the unbacked-up data. In the first level of validation, the data processing engine 206 may compare the size of the unbacked-up data with a predefined threshold data size (e.g., 100 MB, 1 GB, 10 GB, 1 TB, etc.). The predefined threshold data size may user-defined.

When the size of the unbacked-up data is greater than or equal to the predefined threshold data size, the data processing engine 206 may establish successful validation of the first level of validation. The data processing engine 206 may trigger the data backup engine 208 to initiate a data backup of the unbacked-up data. Further, the data backup engine 208 may store the unbacked-up data in a data storage device 216. The data storage device 216 may include a database configured to backup data of the user device 214. In an embodiment, the data storage device 216 may be a cloud server.

When the size of the unbacked-up data is less than the predefined threshold data size, the data processing engine 206 may initiate a second level of validation for data backup. The second level of validation may be based on the time period since previous data backup. In the second level of validation, the data processing engine 206 may compare the time period since previous data backup with a predefined backup time period (e.g., 1 hour, 6 hours, 1 day, 1 week, 1 month, etc.). The predefined backup time period may be user-defined.

When the time period since previous data backup is equal to the predefined backup time period, the data processing engine 206 may establish successful validation of the second level of validation. The data processing engine 206 may trigger the data backup engine 208 to initiate the data backup of the unbacked-up data. Further, the data backup engine 208 may store the unbacked-up data in the database of the data storage device 216.

In some embodiments, the data backup engine 208 may compress the unbacked-up data using a data compression algorithm prior to storing the unbacked-up data in the database of the data storage device 216. The data compression algorithm may be a lossless data compression algorithm, such as, but not limited to, Lempel-Ziv (LZ) compression methods, Lempel-Ziv-Welch (LZW) algorithm, Prediction by Partial Matching (PPM), etc., or a lossy data compression algorithm, such as, but not limited to, Discrete Cosine Transform (DCT), Joint Photographic Experts Group (JPEG), etc. The unbacked-up data may also be encrypted prior to being stored.

Also, until at least one of the first level of validation or the second level of validation is successfully validated, the data processing engine 206 may not trigger the data backup engine 208 to initiate the data backup of the unbacked-up data. Upon unsuccessful validation of the first level of validation, the data processing engine 206 may initiate the second level of validation. Upon unsuccessful validation of the second level of validation, the data processing engine 206 may reinitiate the first level of validation. This cycle is repeated until at least one of the first level of validation and the second level of validation is successful.

Further, upon storing the unbacked-up data in the database of the data storage device 216, the data processing engine 206 may reinitiate the first level of validation. The data processing engine 206 may iteratively compare the size of the unbacked-up data with a predefined threshold data size until the size of the unbacked-up data is greater than or equal to the predefined threshold data size.

Similarly, upon storing the unbacked-up data in the database and when the size of the unbacked-up data is less than the predefined threshold data size, the data processing engine 206 may reinitiate the second level of validation. The data processing engine 206 may iteratively compare the time period since previous data backup with a predefined backup time period.

Further, the data backup engine 208 may determine whether the unbacked-up data is successfully stored in the database or unsuccessfully stored in the database. This may be done through a comparison between the unbacked-up data with the stored unbacked-up data. Further, the data backup engine 208 may render a notification on the user device 214 via a Graphical User Interface (GUI) based on the determining. Some examples of the notification may be “Data backup was successful”, “Data backup was unsuccessful”, “Data backup completed”, “Data backup failed”, etc.

Additionally, the data processing engine 206 may store the set of user data metrics in a historical database. Thus, the historical database may include a set of historical user data metrics. The set of historical user data metrics includes historical data corresponding to the time period since previous data backup and the size of the unbacked-up data. Further, the Al engine 210 may retrieve the set of historical user data metrics. The AI engine 210 may determine an optimal threshold data size and an optimal backup time period corresponding to the user device based on the set of historical user data metrics using the AI model.

The Al engine 210 may generate a backup recommendation corresponding to the user device based on the optimal threshold data size and the optimal backup time period, using the AI model. The backup recommendation may be in natural language. Some non-limiting examples of the backup recommendation may be “Set the backup time period to 1 day”, “The optimal threshold data size based on your data backup activity is 1 TB”, etc. By way of an example, the AI model may be a Large Language Model (LLM) such as Generative Pre-Trained Transformer (GPT), Pathways Language Model (PaLM), Gemini, Grok, Large Language Model Meta Al (LLaMA), or the like. The backup recommendation may optimize data backup management for the user, and may potentially save the user from data loss. Further, the rendering engine 212 may render the backup recommendation via a GUI on the user device 214.

In an embodiment, the rendering engine 212 may render one or more backup options on the user device 214 via a GUI. For example, on a welcome page of a data backup application implemented by the server 200, the rendering engine 212 may render 3 preconfigured backup options to the user based on user backup-a light data generator (i.e., unbacked-up data does not reach a high data size (e.g., 1 GB) over a long time period (e.g., of 1 month)), a heavy data generator (i.e., unbacked-up data reaches a high data size (e.g., 1 GB) over a short time period (e.g., of 1 day)), and a balanced backup plan (i.e., unbacked-up data reaches a high data size (e.g., 1 GB) over a moderate time period (e.g., of 1 week)). The user may be given the 3 preconfigured backup options and also an option to customize the set of user metrics if the user does not prefer any of the 3 preconfigured backup options.

By way of an example, a user associated with the user device 214 may define a set of predefined user data metrics—the predefined threshold data size may be set as 1 GB and the predefined backup time period may be set as 1 day (i.e., daily frequency). The data processing engine 206 may periodically receive the set of user data metrics (i.e., the size of the unbacked-up data and the time period since previous data backup) from the user device 214. The data processing engine 206 may compare the set of user data metrics with the set of predefined user data metrics. The data processing engine 206 may first apply the first validation criteria to determine whether the size of the unbacked-up data is greater than or equal to 1 GB. When the size of the unbacked-up data reaches 1 GB, the data backup engine 208 initiates data backup and stores the unbacked-up data in the data storage device 216. Further, as long as the size of the unbacked-up data is less than 1 GB, the data processing engine 206 may periodically apply the second validation criteria to determine whether the time period since previous data backup is equal to 1 day. When the time period since previous data backup reaches 1 day, the data backup engine 208 may initiate the data backup of the unbacked-up data even if the size of the unbacked-up data is less than 1 GB.

This will ensure regular data backup even when the user device 214 does not have a high size of unbacked-up data. Thus, even if the size of the unbacked-up data is small, the unbacked-up data will be backed-up in accordance with the predefined backup time period and data loss in such cases will be prevented.

It should be noted that all such aforementioned modules 206-212 may be represented as a single module or a combination of different modules. Further, as will be appreciated by those skilled in the art, each of the modules 206-212 may reside, in whole or in parts, on one device or multiple devices in communication with each other. In some embodiments, each of the modules 206-212 may be implemented as dedicated hardware circuit comprising custom application-specific integrated circuit (ASIC) or gate arrays, off-the-shelf semiconductors such as logic chips, transistors, or other discrete components. Each of the modules 206-212 may also be implemented in a programmable hardware device such as a field programmable gate array (FPGA), programmable array logic, programmable logic device, and so forth. Alternatively, each of the modules 206-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for managing data backup. For example, the exemplary system 100 and the associated server 102 may manage data backup by the processes discussed herein. In particular, as will be appreciated by those of ordinary skill in the art, control logic and/or automated routines for performing the techniques and steps described herein may be implemented by the system 100 and the associated server 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

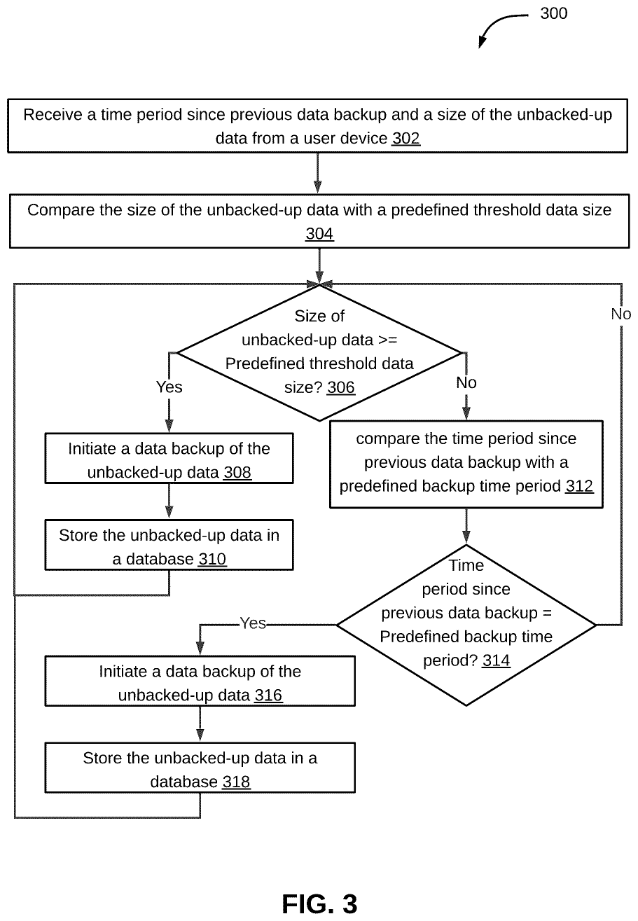

Referring now to FIG. 3, an exemplary process 300 for managing data backup is depicted via a flowchart, in accordance with some embodiments. In an embodiment, the process 300 may be implemented by the server 102 of the system 100. The process 300 may include receiving, by the data processing engine 206, a time period since previous data backup and a size of the unbacked-up data from a user device (for example, the user device 214), at step 302.

Further, the process 300 may include comparing, by the data processing engine 206, the size of the unbacked-up data with a predefined threshold data size, at step 304.

Further, at step 306, a check may be performed by the data processing engine 206 to determine whether the size of the unbacked-up data is greater than or equal to the predefined threshold data size.

When the size of the unbacked-up data is greater than or equal to the predefined threshold data size, the process 300 may include initiating, by the data backup engine 208, a data backup of the unbacked-up data, at step 308. Further, the process 300 may include storing, by the data backup engine 208, the unbacked-up data in a database (for example, the database in the data storage device 216), at step 310.

When the size of the unbacked-up data is less than the predefined threshold data size, the process 300 may include comparing, by the data processing engine 206, the time period since previous data backup with a predefined backup time period, at step 312.

Further, at step 314, a check may be performed to determine whether the time period since previous data backup is equal to the predefined backup time period.

When the time period since previous data backup is equal to the predefined backup time period, the process 300 may include initiating, by the data backup engine 208, the data backup of the unbacked-up data, at step 316. Further, the process 300 may include storing, by the data backup engine 208, the unbacked-up data in the database, at step 318.

When the time period since previous data backup is equal to the predefined backup time period, the check performed at the step 306 may be repeated until the unbacked-up data is successfully stored in the database.

In some embodiments, the process 300 may include determining, by the data backup engine 208, whether the unbacked-up data is successfully stored in the database or unsuccessfully stored in the database. Further, the process 300 may include rendering, by the rendering engine 212, a notification on the user device via a GUI based on the determining.

Further, upon storing the unbacked-up data in the database, the process 300 may include iteratively comparing, by the data processing engine 206, the size of the unbacked-up data with a predefined threshold data size. Thus, upon storing the unbacked-up data in the database, the check performed at step 306 may be repeated. Further, upon storing the unbacked-up data in the database and when the size of the unbacked-up data is less than the predefined threshold data size, the process 300 may include iteratively comparing, by the data processing engine 206, the time period since previous data backup with a predefined backup time period. Thus, upon storing the unbacked-up data in the database and when the check performed at step 306 is not validated, the step 312 may be repeated.

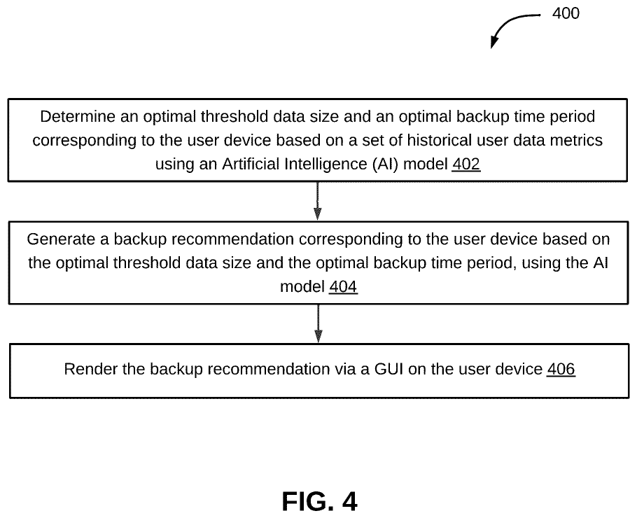

Referring now to FIG. 4, an exemplary process 400 for generating backup recommendations is depicted via a flowchart, in accordance with some embodiments. In an embodiment, the process 400 may be implemented by the server 102 of the system 100. The process 400 may include determining, by the AI engine 210, an optimal threshold data size and an optimal backup time period corresponding to the user device based on a set of historical user data metrics using an AI model, at step 402. The set of historical user data metrics may include historical data corresponding to the time period since previous data backup and the size of the unbacked-up data.

Further, the process 400 may include generating, by the AI engine 210, a backup recommendation corresponding to the user device based on the optimal threshold data size and the optimal backup time period, using the AI model, at step 404. The backup recommendation may be in natural language.

Further, the process 400 may include rendering, by the rendering engine 212, the backup recommendation via a GUI on the user device, at step 406.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

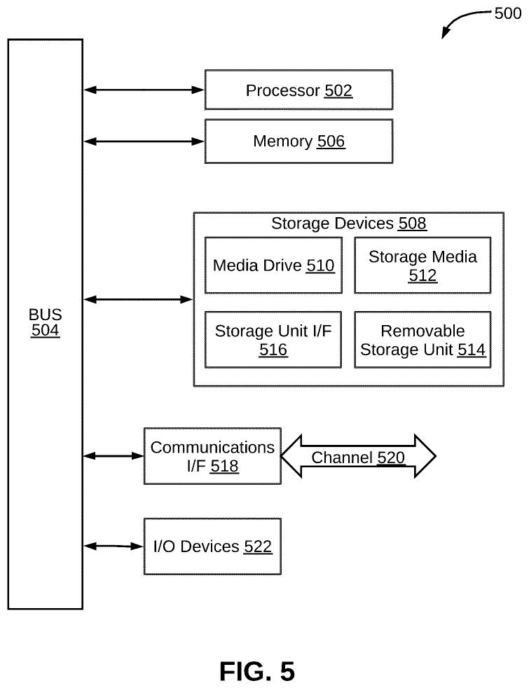

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage device 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method and system try to overcome the technical problem of managing data backup. The method and system improve data availability and protection by efficiently backing up data. Further, the method and system reduce the backup time for exuberant data by ensuring that data is immediately backed up when it reaches a predefined threshold data size. The method and system address the need to reduce the backup time in data protection. For example, data with size of 1 TB takes more time to backup than the data of 1 GB or 50 GB. The volume-based backups ease out such bottlenecks by ensuring that a data of 1 GB is backed up even if it is accumulated in a shorter time span.

As will be appreciated by those skilled in the art, the techniques described in the various embodiments discussed above are not routine, or conventional, or well understood in the art. The techniques discussed above provide for managing data backup. The techniques compare the size of the unbacked-up data with a predefined threshold data size. When the size of the unbacked-up data is greater than or equal to the predefined threshold data size, the techniques initiate a data backup of the unbacked-up data and store the unbacked-up data in a database. This ensures that data is backed up when the data size is high enough even if it increases in a short span of time. This also ensures that tremendously high amount of data is not accumulated as unbacked-up data thus saving backup time. When the size of the unbacked-up data is less than the predefined threshold data size, the techniques compare the time period since previous data backup with a predefined backup time period. When the time period since previous data backup is equal to the predefined backup time period, the techniques initiate the data backup of the unbacked-up data and store the unbacked-up data in the database. This ensures that data is frequently backed up even if the data size is not high enough for a long period of time.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for managing data backup. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing data backup, the method comprising:
receiving, by a server, a time period since previous data backup and a size of unbacked-up data from a user device;
comparing, by the server, the size of the unbacked-up data with a predefined threshold data size;
when the size of the unbacked-up data is greater than or equal to the predefined threshold data size,
initiating, by the server, a data backup of the unbacked-up data; and
storing, by the server, the unbacked-up data in a database; and
when the size of the unbacked-up data is less than the predefined threshold data size,
comparing, by the server, the time period since previous data backup with a predefined backup time period;
when the time period since previous data backup is equal to the predefined backup time period,
initiating, by the server, the data backup of the unbacked-up data; and
storing, by the server, the unbacked-up data in the database.

2. The method of claim 1, further comprising, upon storing the unbacked-up data in the database, iteratively comparing, by the server, the size of the unbacked-up data with a predefined threshold data size.

3. The method of claim 1, further comprising, upon storing the unbacked-up data in the database and when the size of the unbacked-up data is less than the predefined threshold data size, iteratively comparing, by the server, the time period since previous data backup with a predefined backup time period.

4. The method of claim 1, further comprising determining, by the server, whether the unbacked-up data is successfully stored in the database or unsuccessfully stored in the database.

5. The method of claim 4, further comprising rendering, by the server, a notification on the user device via a Graphical User Interface (GUI) based on the determining.

6. The method of claim 1, further comprising:
determining, by the server, an optimal threshold data size and an optimal backup time period corresponding to the user device based on a set of historical user data metrics using an Artificial Intelligence (AI) model, wherein the set of historical user data metrics comprises historical data corresponding to the time period since previous data backup and the size of the unbacked-up data;
generating, by the server, a backup recommendation corresponding to the user device based on the optimal threshold data size and the optimal backup time period, using the Al model, wherein the backup recommendation is in natural language; and
rendering, by the server, the backup recommendation via a GUI on the user device.

7. A system for managing data backup, the system comprising:
a processor; and
a memory communicatively coupled to the processor, wherein the memory stores processor instructions, which when executed by the processor, cause the processor to:
receive a time period since previous data backup and a size of unbacked-up data from a user device;
compare the size of the unbacked-up data with a predefined threshold data size;
when the size of the unbacked-up data is greater than or equal to the predefined threshold data size,
initiate a data backup of the unbacked-up data; and
store the unbacked-up data in a database; and
when the size of the unbacked-up data is less than the predefined threshold data size,
compare the time period since previous data backup with a predefined backup time period;
when the time period since previous data backup is equal to the predefined backup time period,
initiate the data backup of the unbacked-up data; and
store the unbacked-up data in the database.

8. The system of claim 7, wherein the processor instructions, on execution, further cause the processor to, upon storing the unbacked-up data in the database, iteratively compare the size of the unbacked-up data with a predefined threshold data size.

9. The system of claim 7, wherein the processor instructions, on execution, further cause the processor to, upon storing the unbacked-up data in the database and when the size of the unbacked-up data is less than the predefined threshold data size, iteratively compare the time period since previous data backup with a predefined backup time period.

10. The system of claim 7, wherein the processor instructions, on execution, further cause the processor to determine whether the unbacked-up data is successfully stored in the database or unsuccessfully stored in the database.

11. The system of claim 10, wherein the processor instructions, on execution, further cause the processor to render a notification on the user device via a Graphical User Interface (GUI) based on the determining.

12. The system of claim 7, wherein the processor instructions, on execution, further cause the processor to:
determine an optimal threshold data size and an optimal backup time period corresponding to the user device based on a set of historical user data metrics using an Artificial Intelligence (AI) model, wherein the set of historical user data metrics comprises historical data corresponding to the time period since previous data backup and the size of the unbacked-up data;
generate a backup recommendation corresponding to the user device based on the optimal threshold data size and the optimal backup time period, using the AI model, wherein the backup recommendation is in natural language; and
render the backup recommendation via a GUI on the user device.

13. A non-transitory computer-readable medium storing computer-executable instructions for managing data backup, the computer-executable instructions configured for:
receiving a time period since previous data backup and a size of unbacked-up data from a user device;
comparing the size of the unbacked-up data with a predefined threshold data size;
when the size of the unbacked-up data is greater than or equal to the predefined threshold data size,
initiating a data backup of the unbacked-up data; and
storing the unbacked-up data in a database; and
when the size of the unbacked-up data is less than the predefined threshold data size,
comparing the time period since previous data backup with a predefined backup time period;
when the time period since previous data backup is equal to the predefined backup time period,
initiating the data backup of the unbacked-up data; and
storing the unbacked-up data in the database.

14. The non-transitory computer-readable medium of claim 13, wherein the computer-executable instructions are further configured for, upon storing the unbacked-up data in the database, iteratively comparing the size of the unbacked-up data with a predefined threshold data size.

15. The non-transitory computer-readable medium of claim 13, wherein the computer-executable instructions are further configured for, upon storing the unbacked-up data in the database and when the size of the unbacked-up data is less than the predefined threshold data size, iteratively comparing the time period since previous data backup with a predefined backup time period.

16. The non-transitory computer-readable medium of claim 13, wherein the computer-executable instructions are further configured for determining whether the unbacked-up data is successfully stored in the database or unsuccessfully stored in the database.

17. The non-transitory computer-readable medium of claim 16, wherein the computer-executable instructions are further configured for rendering a notification on the user device via a Graphical User Interface (GUI) based on the determining.

18. The non-transitory computer-readable medium of claim 13, wherein the computer-executable instructions are further configured for:
determining an optimal threshold data size and an optimal backup time period corresponding to the user device based on a set of historical user data metrics using an Artificial Intelligence (AI) model, wherein the set of historical user data metrics comprises historical data corresponding to the time period since previous data backup and the size of the unbacked-up data;
generating a backup recommendation corresponding to the user device based on the optimal threshold data size and the optimal backup time period, using the AI model, wherein the backup recommendation is in natural language; and
rendering the backup recommendation via a GUI on the user device.
